(19) United States
(12) Patent Application Publication
(10) Pub. No.: US 2026/0080772 A1
(43) Pub. Date: Mar. 19, 2026

(54) VEHICLE CONTROL DEVICE, NOTIFICATION DEVICE, AND VEHICLE CONTROL METHOD

(71) Applicant: TOYOTA JIDOSHA KABUSHIKI KAISHA, Toyota-shi (JP)

(72) Inventors: Yuki OKAMOTO, Ebina-shi (JP); Go INOUE, Gotenba-shi (JP); Noritsugu IWAZAKI, Sunto-gun (JP); Yuhei OKA, Susono-shi (JP); Daisuke KAKUMA, Susono-shi (JP); Hiroya CHIBA, Fuji-shi (JP); Takeshi KANOU, Seto-shi (JP); Kento OHARA, Nisshin-shi (JP)

(73) Assignee: TOYOTA JIDOSHA KABUSHIKI KAISHA, Toyota-shi (JP)

(21) Appl. No.: 19/256,477

(22) Filed: Jul. 1, 2025

(30) Foreign Application Priority Data
Sep. 19, 2024 (JP) 2024-162461

(51) Int. Cl. G08G 1/01; G08G 1/00

(52) U.S. Cl. CPC G08G 1/0125; G08G 1/0112; G08G 1/0116; G08G 1/22

(57) ABSTRACT

A vehicle control device according to the present disclosure is a vehicle control device that controls an operation of a vehicle traveling in a convoy, and includes a control information acquisition unit, an emergency information acquisition unit, and a travel control unit. The control information acquisition unit acquires control information related to the operation control of the vehicle from the server. The emergency information acquisition unit acquires emergency information, which is information for notifying an emergency situation, from another vehicle traveling in a convoy. When the emergency information acquisition unit has not acquired the emergency information, the travel control unit controls the operation of the vehicle based on the control information, and when the emergency information acquisition unit has acquired the emergency information, the travel control unit controls the operation of the vehicle so as to execute the emergency operation.

### CROSS-REFERENCE TO RELATED APPLICATION

This application claims priority to Japanese Patent Application No. 2024-162461 filed on Sep. 19, 2024. The disclosure of the above-identified application, including the specification, drawings, and claims, is incorporated by reference herein in its entirety.

### BACKGROUND

### 1. Technical Field

The present disclosure relates to a vehicle control device, a notification device, and a vehicle control method.

### 2. Description of Related Art

Japanese Unexamined Patent Application Publication No. 2022-057152 (JP 2022-057152 A) describes a control device that controls the traveling state of at least one of a plurality of vehicles that travels in a convoy.

### SUMMARY

When one of vehicles that travel in a convoy is stopped in an emergency, for example, it is necessary to also stop the following vehicles in an emergency. Here, when the responsiveness for the emergency stop of the following vehicles is low, there is an issue that the distance between the vehicles is reduced due to the emergency stop, and disturbance occurs in the convoy. JP 2022-057152 A does not disclose a technique capable of addressing such an issue.

The present disclosure has been made to address such an issue, and has an object to provide a vehicle control device, a notification device, and a vehicle control method capable of improving the responsiveness for emergency operation.

An aspect of the present disclosure provides a vehicle control device that controls operation of a vehicle that travels in a convoy, the vehicle control device including a control information acquisition unit, an emergency information acquisition unit, and a travel control unit.
The control information acquisition unit acquires control information relating to operation control for the vehicle from a server.
The emergency information acquisition unit acquires emergency information that is information that indicates an emergency situation from a different vehicle that travels in the convoy.
The travel control unit controls the operation of the vehicle based on the control information when the emergency information acquisition unit does not acquire the emergency information, and controls the operation of the vehicle so as to execute emergency operation when the emergency information acquisition unit acquires the emergency information.

With such a configuration, the vehicle control device according to the present embodiment can execute the operation control for handling the emergency situation without executing communication via the server. As a result, the vehicle control device can improve the responsiveness for the emergency operation of the vehicle.

In the vehicle control device according to an aspect of the present disclosure, the emergency information acquisition unit may acquire the emergency information from a vehicle that travels ahead in the convoy.

The vehicle control device according to an aspect of the present disclosure may further include a transmission unit that transmits the emergency information to a vehicle that travels behind in the convoy when the emergency information acquisition unit acquires the emergency information.

An aspect of the present disclosure provides a notification device mounted on a vehicle that travels in a convoy, the notification device including
an emergency situation detection unit and an emergency information output unit.
The emergency situation detection unit detects occurrence of an emergency situation.
The emergency information output unit outputs emergency information that indicates the occurrence of the emergency situation to a different vehicle that travels in the convoy based on external control from a server.

An aspect of the present disclosure provides a vehicle control method of controlling operation of a vehicle that travels in a convoy.
The vehicle control method according to the aspect of the present disclosure includes acquiring control information relating to operation control for the vehicle from a server.
The method also includes controlling the operation of the vehicle based on the control information when emergency information that is information that indicates an emergency situation is not acquired from a different vehicle that travels in the convoy.
The method further includes controlling the operation of the vehicle so as to execute emergency operation when the emergency information is acquired from the different vehicle that travels in the convoy.

According to the aspect of the present disclosure, it is possible to provide a vehicle control device, a notification device, and a vehicle control method capable of improving the responsiveness for emergency operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic overhead view showing a configuration of a control system according to a first embodiment;

FIG. 2 is a block diagram illustrating a configuration of a server according to the first embodiment;

FIG. 3 is a block diagram illustrating a configuration of a vehicle according to the first embodiment;

FIG. 4 is a block diagram illustrating a configuration of a vehicle control device according to the first embodiment;

FIG. 5 is a flowchart illustrating a control method according to the first embodiment;

FIG. 6 is a flowchart showing a control process according to the first embodiment; and

FIG. 7 is a flowchart illustrating a control method according to the first embodiment.

### DETAILED DESCRIPTION OF EMBODIMENTS

### First Embodiment

### Configuration of Vehicle Control System

Hereinafter, a first embodiment according to the present disclosure will be described in detail with reference to the drawings. First, a configuration of a vehicle control device according to the present embodiment will be described.

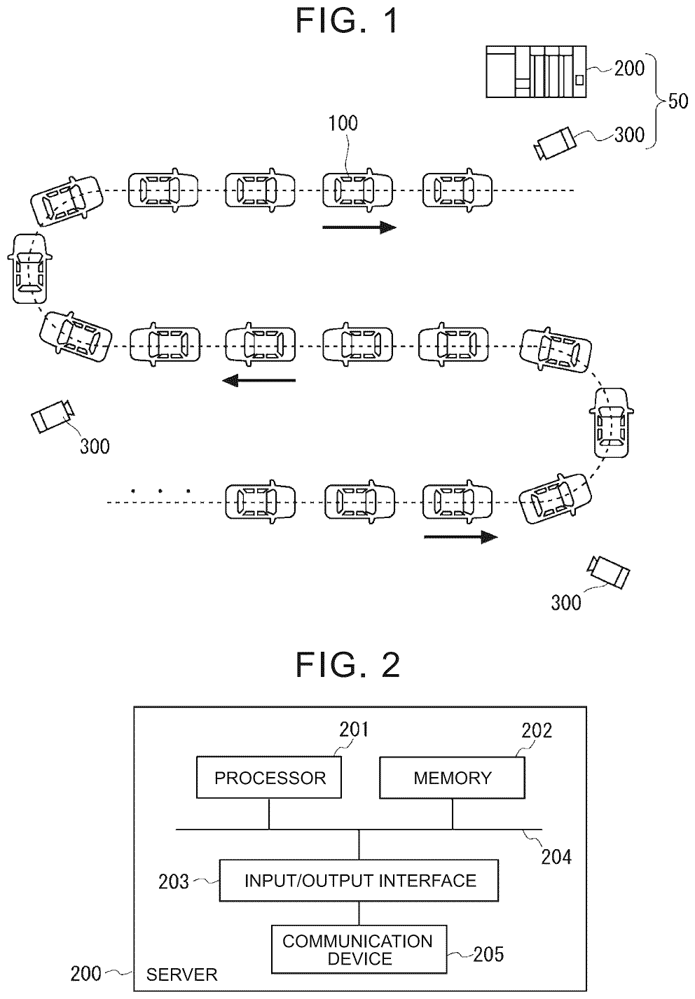

FIG. 1 is a schematic overhead view for explaining a configuration of a control system 50 according to the present embodiment and a vehicle 100 to be controlled. The vehicle control device 110 according to the present embodiment is a device mounted on each of the vehicles 100 that execute the convoy travel as shown in FIG. 1, and controls the operation of the vehicle 100 on which the vehicle is mounted. The vehicle 100 according to the present embodiment controls the operation of the vehicle 100 based on the control by the control system 50.

The control system 50 includes a server 200 and an external sensor 300, and controls the convoy travel of the plurality of vehicles 100 as described above. Although details will be described later, the control system 50 according to the present embodiment outputs control information of the vehicle 100 and transmits the control information to the vehicle 100. Then, the vehicle 100 that has received the control information performs the unmanned driving based on the control information, thereby executing the convoy travel.

Here, the term “unmanned driving” means driving that does not depend on the traveling operation of the passenger. Further, the traveling operation means an operation related to at least one of “running”, “turning”, and “stopping”of the vehicle 100.

However, a passenger who does not perform the traveling operation may be on the vehicle 100 traveling by the unmanned driving. The passenger who does not perform the traveling operation includes, for example, a person who is simply seated on the seat of the vehicle 100, and a passenger who performs a work different from the traveling operation such as an assembling operation, an inspection operation, and a switch operation while riding on the vehicle 100.

The control system 50 can be used for any purpose as long as it runs a plurality of vehicles in a convoy. For example, the control system 50 may be used to convey a plurality of vehicles manufactured in a vehicle manufacturing factory to a yard. In addition, the control system 50 may be used to load a plurality of vehicles into a ship or a freight train. In addition, the control system 50 may be used to run unfinished vehicles in a fleet at a vehicle manufacturing factory.

FIG. 2 is a block diagram illustrating a configuration of the server 200 according to the first embodiment. The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each external sensor 300 by wired communication or wireless communication. The processor 201 implements various functions by executing program PG2 stored in the memory 202.

The server 200 acquires the detection result by the sensor, and generates control information for controlling the actuator group of the vehicle 100 using the detection result. The server 200 transmits the control information to the vehicle 100 to cause the vehicle 100 to travel by remote control. The server 200 may generate and output not only the control information related to the travel of the vehicle 100 but also a control signal for controlling various accessories provided in the vehicle 100 and actuators for operating various kinds of equipment such as a wiper, a power window, and a lamp. That is, the server 200 may operate the various types of equipment and the various auxiliary devices by remote control.

The external sensor 300 is a sensor located outside the vehicle 100. The external sensor 300 in the present embodiment is a sensor that captures the vehicle 100 from the outside of the vehicle 100. The external sensor 300 includes a communication device (not shown), and can communicate with another device such as the server 200 by wired communication or wireless communication.

Specifically, the external sensor 300 according to the present embodiment is constituted by a camera. The camera as the external sensor 300 captures a captured image including the vehicle 100, and outputs the captured image as a detection result. However, the configuration of the external sensor 300 is not limited to this, and the external sensor 300 may be, for example, a LiDAR (Light Detection And Ranging), a millimeter-wave radar, an ultrasonic sensor, or the like. That is, the external sensor 300 may be any sensor that outputs a detection result that can be used for specifying the position information of the vehicle 100.

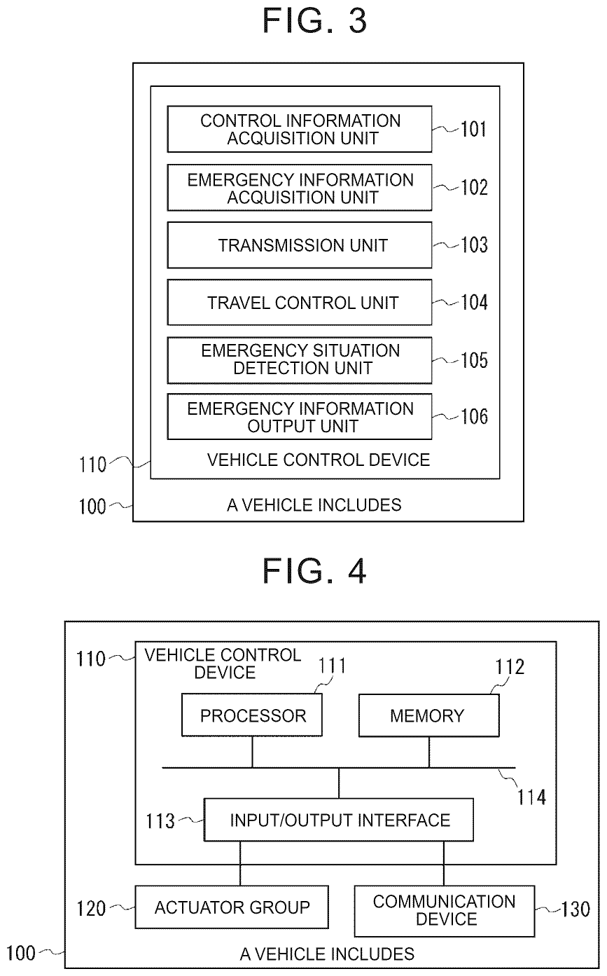

FIG. 3 is a block diagram illustrating a configuration of a vehicle according to the present embodiment. The vehicle 100 is a vehicle that travels in a convoy by unmanned driving. More specifically, the vehicle 100 according to the present embodiment includes the vehicle control device 110, and performs the unmanned driving based on the control of the vehicle control device 110 that has acquired the control information from the server 200.

The vehicle control device 110 according to the present embodiment includes a control information acquisition unit 101, an emergency information acquisition unit 102, a transmission unit 103, a travel control unit 104, an emergency situation detection unit 105, and an emergency information output unit 106 as functional blocks.

The control information acquisition unit 101 acquires control information related to operation control of the vehicle 100 from the server 200. More specifically, the control information acquisition unit 101 acquires control information of the vehicle 100 from the server 200 via wireless communication. The control information acquisition unit 101 outputs the acquired control information to the travel control unit 104.

In the present embodiment, the control information includes the acceleration and the steering angle of the vehicle 100 as parameters. In other embodiments, the control signal may include the speed of the vehicle 100 as a parameter in place of or in addition to the acceleration of the vehicle 100.

The emergency information acquisition unit 102 acquires emergency information, which is information for notifying an emergency situation, from another vehicle 100 traveling in a convoy. The emergency information acquisition unit 102 outputs the acquired emergency information to the travel control unit 104. More specifically, the emergency information acquisition unit 102 acquires emergency information from another vehicle 100 by executing inter-vehicle communication using the communication devices respectively included in the vehicle 100.

Here, the emergency information is information for notifying the occurrence of an emergency situation to another vehicle 100 traveling in a convoy based on external control from the server 200. In addition, the term “emergency situation” as used herein refers to a situation in which the vehicle 100 needs to execute a response operation with high readiness, and for example, refers to a situation in which an operator jumps out or a part of the vehicle 100 stops due to a communication failure or the like.

Here, the emergency information acquisition unit 102 may acquire the emergency information from another vehicle 100 traveling in one direction in the convoy travel. In addition, the vehicle 100 may transmit the emergency information to the other vehicle 100 traveling one rear side in the convoy travel when the emergency information acquisition unit 102 acquires the emergency information. In other words, when the emergency information acquisition unit 102 acquires the emergency information, the transmission unit 103 may be provided to transmit the emergency information to the vehicle 100 traveling one rear side in the convoy travel. That is, in the control system 50 according to the present embodiment, when one vehicle 100 transmits the emergency information, the emergency information may be transmitted to the rear vehicles one by one in order.

However, the method of transmitting the emergency information according to the present disclosure is not limited to the above, and for example, the vehicle 100 that transmits the emergency information may transmit the emergency information to two or more vehicles 100. Further, for example, the vehicle 100 that transmits the emergency information may transmit the emergency information from the vehicle 100 to the vehicle 100 that is within a predetermined range. Further, for example, the vehicle 100 that transmits the emergency information may transmit the emergency information to all the vehicles 100 controlled by the server 200. In addition, the emergency information is not limited to information notified from another vehicle when an emergency situation occurs, and may be information indicating that the notification that has been notified from another vehicle continuously in a normal state has been interrupted. That is, the method for transmitting emergency information according to the present disclosure may have any configuration as long as the vehicle 100 under the control of the server 200 transmits the emergency information to another vehicle 100 under the control of the server 200.

The travel control unit 104 controls the operation of the vehicle based on the control information when the emergency information acquisition unit 102 does not acquire the emergency information, and controls the operation of the vehicle so as to execute the emergency operation when the emergency information acquisition unit 102 acquires the emergency information.

Here, the emergency operation is an operation for coping with the above-described emergency situation, and is an operation that is preferably executed with high readiness. Examples of the emergency operation include a temporary stop of running in a convoy, an operation of retracting the vehicle 100 into a predetermined space, and the like.

That is, the vehicle control device 110 according to the present embodiment controls the convoy travel of the vehicle 100 based on the control from the server 200 in a normal state. Then, when the emergency information is acquired, that is, when an emergency situation occurs, the convoy travel of the vehicle 100 is controlled based on the inter-vehicle communication described above instead of the control from the server 200. According to such a configuration, the vehicle control device 110 according to the present embodiment can execute the operation control for responding to the emergency without executing the communication via the server. As a result, the vehicle control device 110 can improve the readiness of the emergency operation of the vehicle 100.

In the present embodiment, the emergency information is output by the vehicle 100 that has detected the occurrence of an emergency, and is transmitted to the other vehicle 100 via inter-vehicle communication. Therefore, the vehicle 100 according to the present embodiment includes an emergency situation detection unit 105 that detects occurrence of an emergency, and an emergency information output unit 106 that outputs emergency information.

The emergency situation detection unit 105 acquires, for example, a detection result of an in-vehicle sensor provided to the vehicle 100, and detects the occurrence of an emergency based on the acquired detection result. Here, the in-vehicle sensor may be any sensor as long as it can output a detection result that can be used for the occurrence of an emergency situation, and is, for example, an in-vehicle camera or the like. When the in-vehicle sensor is an in-vehicle camera, the emergency situation detection unit 105 may acquire, for example, an image of the outside of the vehicle 100 captured by the in-vehicle camera. The emergency situation detection unit 105 may detect the occurrence of an emergency by performing image processing on the captured image.

The emergency information output unit 106 outputs emergency information for notifying the occurrence of an emergency situation to another vehicle 100 traveling in a convoy based on external control from the server 200. The emergency information output by the emergency information output unit 106 is transmitted to the other vehicle 100 by performing inter-vehicle communication as described above.

In other words, the vehicle control device 110 according to the present embodiment can notify other vehicles 100 under the control of the server 200 of the occurrence of an emergency situation. Therefore, the vehicle control device 110 according to the present embodiment may be referred to as a notification device.

FIG. 4 is a block diagram for explaining the configuration of the vehicle 100 in more detail. The vehicle 100 includes a vehicle control device 110 for controlling each unit of the vehicle 100, an actuator group 120 including one or more actuators driven under the control of the vehicle control device 110, and a communication device 130 for wirelessly communicating with an external device such as the server 200.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113.

The processor 111 executes programming PG1 stored in the memories 112. Accordingly, various functions including functions as the control information acquisition unit 101, the emergency information acquisition unit 102, the transmission unit 103, the travel control unit 104, the emergency situation detection unit 105, and the emergency information output unit 106 are realized.

The actuator group 120 includes an actuator of a driving device for accelerating the vehicle 100, an actuator of a steering device for changing a traveling direction of the vehicle 100, and an actuator of a braking device for decelerating the vehicle 100.

The communication device 130 performs communication with the server 200 and other vehicles that perform the convoy travel. The communication device 130 receives control signals from the server 200. The communication device 130 outputs the received control signal to the vehicle control device 110.

The communication device 130 is configured to transmit and receive emergency information to and from another vehicle 100. When the emergency information is acquired from another vehicle 100, the communication device 130 outputs the acquired emergency information to the vehicle control device 110. When the emergency information output from the vehicle control device 110 is acquired, the communication device 130 transmits the acquired emergency information to the other vehicle 100.

### Operation of Vehicle Control Device

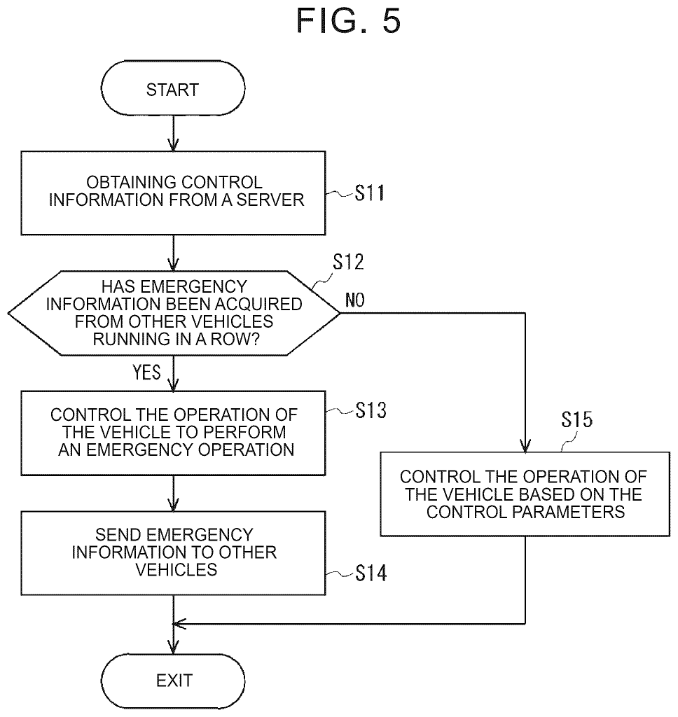

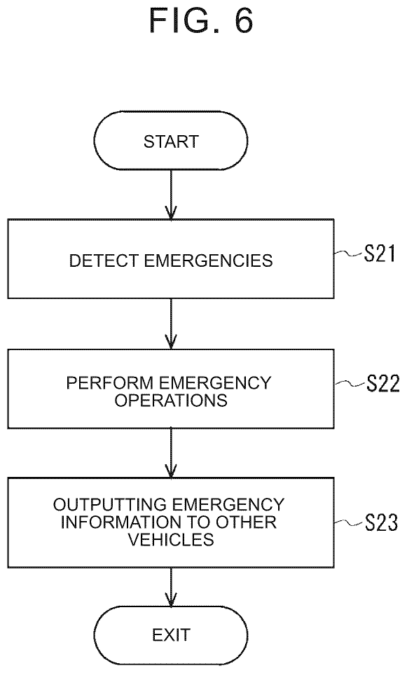

Next, the operation of the vehicle control device according to the present embodiment, that is, the vehicle control method according to the present embodiment will be described in more detail. FIG. 5 and FIG. 6 are flowcharts for explaining the vehicle control method according to the first embodiment. In the following description, FIG. 2, FIG. 3, and FIG. 4 will be referred to as appropriate.

First, the processing procedure shown in FIG. 5 will be described in detail. In the processing procedure of FIG. 5, the processor 111 of the vehicle control device 110 executes the program PG1 to function as the control information acquisition unit 101, the emergency information acquisition unit 102, the transmission unit 103, and the travel control unit 104.

First, the processor 111 controls data from the servers 200 (S11). More specifically, the processor 111 acquires control information from the server 200 via the communication device 205 and the communication device 130. In S11, the processor 111 executes a function as the control information acquisition unit 101.

Next, the processor 111 determines whether or not the urgent data has been acquired from the other vehicles 100 traveling in the convoy (S12). In S12, the processor 111 executes a function as the travel control unit 104.

When the emergency-information is not acquired from another vehicle running in the convoy (S12NO), the processor 111 controls the operation of the vehicle 100 based on the control parameter (S15), and ends the series of operations. The processor 111 repeats the above-described series of operations at a predetermined cycle. That is, in S15, the processor 111 controls the operation of the vehicles 100 based on the control from the servers 200. A detailed control mode in this case will be described later. In S15, the processor 111 executes a function as the travel control unit 104.

When the emergency information is acquired from another vehicle running in the convoy (S12YES), the processor 111 controls the operation of the vehicle 100 to execute the emergency operation (S13). In other words, in S13, the processor 111 controls the operation of the vehicle 100 based on the urgent data obtained from the other vehicle 100. In S15, the processor 111 executes functions as the emergency information acquisition unit 102 and the travel control unit 104.

The processor 111 then transmits S14 to the other vehicles 100 to terminate the sequence of operations. The processor 111 repeats the above-described series of operations at a predetermined cycle. In S14, the processor 111 executes a function as the transmission unit 103. However, the order in which S13 and S14 are executed may be reversed. S13 and S14 may be executed in parallel.

Next, the processing procedure shown in FIG. 6 will be described in detail. In the process of FIG. 6, the processor 111 of the vehicle control device 110 executes the program PG1 to function as the travel control unit 104, the emergency situation detection unit 105, and the emergency information output unit 106. That is, in the processing procedure of FIG. 5, the vehicle control device 110 functions as the vehicle control device according to the present embodiment, and also functions as the notification device according to the present embodiment.

Initially, the processor 111 detects occurrence of an emergent event (S21). In S21, the processor 111 executes a function as the emergency situation detection unit 105.

The processor 111 then S22 the emergency operation. In S21, the processor 111 executes a function as the travel control unit 104.

The processor 111 then S23 the other vehicles 100 and terminates the sequence of operations. The processor 111 repeats the above-described series of operations at a predetermined cycle. In S23, the processor 111 executes a function as the emergency information output unit 106. Here, the order in which S22 and S23 are executed may be reversed. S22 and S23 may be executed in parallel.

With such a configuration, the vehicle control device 110 according to the present embodiment can appropriately execute the emergency operation even when the vehicle control device itself detects an emergency situation. Further, with such a configuration, the vehicle control device 110 according to the present embodiment can appropriately notify other vehicles 100 under the control of the server 200 of the emergency detected by itself.

### Method for Controlling Vehicle by Server

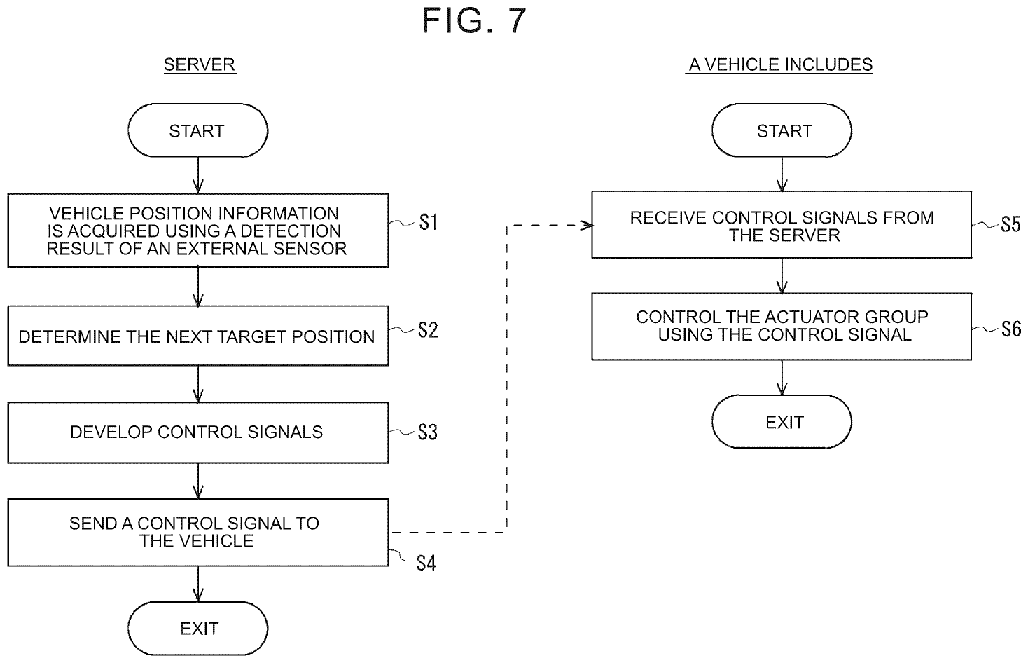

FIG. 7 is a flowchart illustrating a processing procedure of travel control of the vehicle 100 according to the first embodiment. In the process of FIG. 7, the processor 201 of the server 200 executes the program PG2 to control the vehicles 100.

The process sequence of the travel control described below corresponds to S11 and S15 in the flowchart shown in FIG. 5. That is, in the travel control mode described below, the travel control in the case where the emergency information is not acquired, that is, the travel control by the server 200 is described in detail.

In S1, the processor 201 of the server 200 acquires the vehicle position information of the vehicle 100 using the detection result output from the external sensor 300. The vehicle position information is base position information for generating a control signal. In the present embodiment, the vehicle position information includes the position and orientation of the vehicle 100 in the global coordinate system of the factory.

Specifically, in S1, the processor 201 acquires vehicle-position data using captured images acquired from cameras that are the external sensors 300. Specifically, in S1, for example, the processor 201 detects the outer shape of the vehicle 100 from the captured image, and calculates the coordinates of the positioning point of the vehicle 100 in the coordinate system of the captured image, that is, the local coordinate system. The processor 201 obtains the position of the vehicle 100 by converting the calculated coordinates into coordinates in the global coordinate system.

The outline of the vehicle 100 included in the captured image can be detected by, for example, inputting the captured image into a detection model DM using artificial intelligence. The detection model DM is prepared in the control system 50 or outside the control system 50, for example, and stored in advance in the memories 202 of the servers 200.

The detection model DM may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM.

Further, the processor 201 can obtain the direction of the vehicle 100 by estimating the direction of the movement vector of the vehicle 100 calculated from the position change of the feature point of the vehicle 100 between the frames of the captured image using, for example, the optical flow method.

In S2, the processor 201 of the servers 200 determines the target location to which the vehicles 100 should be heading next. In the present embodiment, the target position is represented by the coordinates of X, Y, Z in the global coordinate system. In the memory 202 of the server 200, a reference route that is a route on which the vehicle 100 should travel is stored in advance. The route is represented by a node indicating a starting point, a node indicating a passing point, a node indicating a destination, and a link connecting the respective nodes. The processor 201 uses the vehicle position information and the reference path to determine a target position to which the vehicle 100 is to be directed next. The processor 201 determines the target position on the reference route ahead of the current position of the vehicle 100.

In S3, the processor 201 of the servers 200 generates control signaling to cause the vehicles 100 to travel toward the determined target location. The processor 201 calculates the traveling speed of the vehicle 100 from the transition of the position of the vehicle 100, and compares the calculated traveling speed with the target speed. The processor 201 generally determines the acceleration so that the vehicle 100 accelerates when the travel speed is lower than the target speed, and determines the acceleration so that the vehicle 100 decelerates when the travel speed is higher than the target speed.

The processor 201 may also determine the steering angle and acceleration so that the vehicle 100 does not deviate from the reference path when the vehicle 100 is located on the reference path. If the vehicle 100 is not located on the reference path, in other words, if the vehicle 100 is deviating from the reference path, the processor 201 determines the steering angle and acceleration so that the vehicle 100 returns on the reference path.

In S4, the processor 201 of the servers 200 transmits the generated control signals to the vehicles 100. The processor 201 repeats acquisition of a position of the vehicle 100, determination of a target position, generation of a control signal, transmission of a control signal, and the like at a predetermined cycle.

In S5, the processor 111 of the vehicle 100 receives control signals transmitted from the servers 200.

At S6, the processor 111 of the vehicle 100 controls the actuator group 120 using the received control signal to cause the vehicle 100 to travel at the accelerations and steering angles represented by the control signal. The processor 111 repeatedly receives the control signal and controls the actuator group 120 at a predetermined cycle.

According to such a travel control mode, the vehicle 100 can be driven by remote control, and the vehicle 100 can be moved without using a conveyance facility such as a crane or a conveyor.

As described above, the vehicle control device 110 according to the present embodiment controls the convoy traveling of the vehicle 100 based on the control from the server 200 in a normal state, and controls the convoy traveling of the vehicle 100 based on the inter-vehicle communication described above instead of the control from the server 200 in a case where the emergency information is acquired, that is, in a case where an emergency situation occurs. According to such a configuration, the vehicle control device 110 according to the present embodiment can execute the operation control for responding to the emergency without executing the communication via the server. As a result, the vehicle control device 110 can improve the readiness of the emergency operation of the vehicle 100.

### YY and Other Embodiments

### YY1

In each of the above embodiments, the external sensor 300 is a camera. On the other hand, the external sensor 300 may not be a camera, and may be, for example, a LiDAR (Light Detection And Ranging). In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.

### YY2

In the first embodiment, the server 200 executes processing from acquisition of vehicle position information to generation of a control signal. On the other hand, at least a part of the processing from the acquisition of the vehicle position information to the generation of the control signal may be executed by the vehicle 100. For example, the following forms (1) to (3) may be used.
(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a control signal such that the vehicle 100 travels on a route received from the server 200, and control the actuator group 120 using the generated control signal.
(2) The server 200 may acquire the vehicle position information and transmit the acquired vehicle position information to the vehicle 100. The vehicle 100 may determine a target position to which the vehicle 100 should be directed next, generate a route from the current position of the vehicle 100 represented by the received vehicle position information to the target position, generate a control signal such that the vehicle 100 travels on the generated route, and control the actuator group 120 using the generated control signal.
(3) In the above embodiments (1) and (2), an internal sensor may be mounted on the vehicle 100, and a detection result output from the internal sensor may be used for at least one of generation of a route and generation of a control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the embodiment (1), the server 200 may acquire the detection result of the internal sensor and reflect the detection result of the internal sensor in the path when generating the path. In the aspect (1), the vehicle 100 may acquire the detection result of the internal sensor and reflect the detection result of the internal sensor in the control signal when generating the control signal. In the aspect (2), the vehicle 100 may acquire the detection result of the internal sensor and reflect the detection result of the internal sensor in the path when generating the path. In the aspect (2), the vehicle 100 may acquire the detection result of the internal sensor and reflect the detection result of the internal sensor in the control signal when generating the control signal.

### YY3

In the above-described embodiment, an internal sensor may be mounted in the vehicle 100, and a detection result output from the internal sensor may be used for at least one of generation of a route and generation of a control signal. For example, the vehicle 100 may acquire the detection result of the internal sensor and reflect the detection result of the internal sensor on the route when generating the route. The vehicle 100 may acquire the detection result of the internal sensor and reflect the detection result of the internal sensor in the control signal when generating the control signal.

### YY4

In the above-described embodiment, the vehicle 100 acquires the vehicle position information using the detection result of the external sensor 300. On the other hand, an internal sensor is mounted in the vehicle 100. The vehicle 100 may acquire the vehicle position information using the detection result of the internal sensor, determine a target position to which the vehicle 100 should be directed next, generate a route from the current position of the vehicle 100 represented by the acquired vehicle position information to the target position, generate a control signal for traveling the generated route, and control the actuator group 120 using the generated control signal. In this case, the vehicle 100 can travel without using any detection result of the external sensor 300. Note that the vehicle 100 may acquire the target arrival time and the congestion information from the outside of the vehicle 100 and reflect the target arrival time and the congestion information on at least one of the route and the control signal.

### YY5

In the first embodiment, the server 200 automatically generates a control signal to be transmitted to the vehicle 100. On the other hand, the server 200 may generate a control signal to be transmitted to the vehicle 100 in accordance with an operation of an external operator located outside the vehicle 100. For example, an external operator may operate a control device including a display for displaying a captured image output from the external sensor 300, a steering for remotely controlling the vehicle 100, an accelerator pedal, a brake pedal, and a communication device for communicating with the server 200 through wired communication or wireless communication, and the server 200 may generate a control signal corresponding to an operation applied to the control device.

### YY6

In each of the above-described embodiments, the vehicle 100 may have a configuration that can be moved by unmanned driving, and may be, for example, in the form of a platform having a configuration described below. Specifically, the vehicle 100 may include at least the vehicle control device 110 and the actuator group 120 in order to perform three functions of “running,” “turning,” and “stopping” by unmanned driving. When the vehicle 100 acquires information from the outside for unmanned driving, the vehicle 100 may further include a communication device 130. That is, the vehicle 100 that can be moved by the unmanned driving may not be equipped with at least a part of an interior component such as a driver's seat or a dashboard. At least a part of an exterior component such as a bumper or a fender may not be attached, and the body shell may not be attached. In this case, the remaining components, such as the body shell, may be mounted on the vehicle 100 until the vehicle 100 is shipped from the factory After the vehicle 100 is shipped from the factory in a state where the remaining components such as the body shell are not attached to the vehicle 100, the remaining components such as the body shell may be attached to the vehicle 100. Each of the components may be mounted from any direction, such as the upper side, lower side, front side, rear side, right side or left side of the vehicle 100, each may be mounted from the same direction, or may be mounted from a different direction. It should be noted that the position determination can also be performed for the form of the platform in the same manner as the vehicle 100 according to the first embodiment.

### YY7

The vehicle 100 may be manufactured by combining a plurality of modules. The module means a unit composed of a plurality of components arranged in accordance with a part or a function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the components constituting the platform, the components constituting a part of the vehicle 100 different from the platform may be modularized. Further, the various modules may include any exterior parts such as bumpers and grills, and any interior parts such as sheets and consoles. In addition, not only the vehicle 100 but also a moving object of an arbitrary mode may be manufactured by combining a plurality of modules. Such a module may be manufactured, for example, by joining a plurality of parts by welding, a fixture, or the like, or may be manufactured by integrally molding at least a part of the parts constituting the module as one part by casting. Molding techniques for integrally molding one part, in particular a relatively large part, are also called gigacasts or megacasts. For example, the front module, the central module, and the rear module described above may be manufactured using gigacast.

### YY8

In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

### SUPPLEMENT

In the above-described embodiment, the control target of the control system is the vehicle, but the control target of the control system according to the present disclosure is not limited to the vehicle. That is, the control system according to the present disclosure can control all the moving objects that can travel in a convoy. However, in the present disclosure, the “moving object” means a movable object, and is, for example, a vehicle or an electric vertical takeoff and landing machine (so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV), gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling”can be appropriately replaced with “moving”.

Transporting the vehicle 100 by using the traveling of the vehicle 100 by the unmanned driving is also referred to as “self-propelled conveyance”. A configuration for realizing self-propelled conveyance is also referred to as a “vehicle remote control autonomous driving conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

The present disclosure is not limited to the above embodiments, and can be appropriately modified without departing from the spirit thereof.

What is claimed is:

1. A vehicle control device that controls operation of a vehicle that travels in a convoy, the vehicle control device including:
a control information acquisition unit that acquires control information relating to operation control for the vehicle from a server;
an emergency information acquisition unit that acquires emergency information that is information that indicates an emergency situation from a different vehicle that travels in the convoy; and
a travel control unit that controls the operation of the vehicle based on the control information when the emergency information acquisition unit does not acquire the emergency information, and that controls the operation of the vehicle so as to execute emergency operation when the emergency information acquisition unit acquires the emergency information.

2. The vehicle control device according to claim 1, wherein the emergency information acquisition unit acquires the emergency information from a vehicle that travels ahead in the convoy.

3. The vehicle control device according to claim 1, further comprising a transmission unit that transmits the emergency information to a vehicle that travels behind in the convoy when the emergency information acquisition unit acquires the emergency information.

4. A notification device mounted on a vehicle that travels in a convoy, the notification device comprising:
an emergency situation detection unit that detects occurrence of an emergency situation; and
an emergency information output unit that outputs emergency information that indicates the occurrence of the emergency situation to a different vehicle that travels in the convoy based on external control from a server.

5. A vehicle control method of controlling operation of a vehicle that travels in a convoy, the vehicle control method comprising:
acquiring control information relating to operation control for the vehicle from a server;
controlling the operation of the vehicle based on the control information when emergency information that is information that indicates an emergency situation is not acquired from a different vehicle that travels in the convoy; and
controlling the operation of the vehicle so as to execute emergency operation when the emergency information is acquired from the different vehicle that travels in the convoy.
